(19) United States
(12) Patent Application Publication
(10) Pub. No.: US 2024/0160146 A1
(43) Pub. Date: May 16, 2024

(54) CONDUCTIVE CONNECTION STRUCTURE AND IMAGE-FORMING APPARATUS

(71) Applicant: Zhuhai Pantum Electronics Co., Ltd., Zhuhai (CN)

(72) Inventors: Xiangchao XIA, Zhuhai (CN); Xing PENG, Zhuhai (CN); Chen CAI, Zhuhai (CN)

(21) Appl. No.: 18/507,974

(22) Filed: Nov. 13, 2023

(30) Foreign Application Priority Data
Nov. 14, 2022 (CN) 202211419788.0

(51) Int. Cl. G03G 21/18; B41J 2/175

(52) U.S. Cl. CPC G03G 21/1867; B41J 2/1753

(57) ABSTRACT

The present disclosure provides a conductive connection structure and an image-forming apparatus. The conductive connection structure includes a conductive part where the conductive part includes a first connection portion and a second connection portion. The first connection portion is electrically connected to a reference-ground supply part disposed in a main body of an image-forming apparatus through a first connection part, in order to be connected to a potential reference point provided by the reference-ground supply part; and the second connection portion is electrically connected to the reference-ground supply part through a second connection part, where the first connection part is different from the second connection part, the first connection part is not included in the second connection part, and the second connection part is not included in the first connection part.

### CROSS-REFERENCE TO RELATED APPLICATION

The present disclosure claims the priority to Chinese patent application No. 202211419788.0, filed on Nov. 14, 2022, the entirety of which is incorporated herein by reference.

### TECHNICAL FIELD

The present disclosure generally relates to the field of image-forming technology and, more particularly, relates to a conductive connection structure and image-forming apparatus.

### BACKGROUND

Currently, image-forming apparatuses such as printers, copiers, faxes and multifunctional machines are detachably installed with process cartridges for image formation. The process cartridge may be an ink cartridge, a toner cartridge or the like. The process cartridge is disposed with a process cartridge chip. The process cartridge chip is disposed with four contacts respectively including a power contact (e.g., volt current condenser VCC), a data signal contact (e.g., serial data SDA), a clock signal contact (e.g., CLK) and a grounding contact (GND).

In the image-forming apparatus, each sheet metal of the image-forming apparatus is grounded and electrically connected to each other. A data board of the image-forming apparatus is fixed on the sheet metal of the main body of the image-forming apparatus through locking screws, thereby achieving grounding. The data board is connected to a part of conductive terminals disposed on the image-forming apparatus. When the process cartridge is installed on the image-forming apparatus, another part of the conductive terminals may be electrically connected to conductive contacts of the process cartridge chip. In such way, the process cartridge chip may communicate with the data board and achieve grounding through the data board.

However, if the electrical connection between the conductive terminals disposed on the image-forming apparatus and the data board is unstable, it may result in not direct grounding, abnormal grounding and the like of the process cartridge chip, thereby affecting communication between the process cartridge chip and the image-forming apparatus.

### SUMMARY

One aspect of the present disclosure provides a conductive connection structure. The conductive connection structure includes a conductive part where the conductive part includes a first connection portion and a second connection portion. The first connection portion is electrically connected to a reference-ground supply part disposed in a main body of an image-forming apparatus through a first connection part, in order to be connected to a potential reference point provided by the reference-ground supply part; and the second connection portion is electrically connected to the reference-ground supply part through a second connection part, where the first connection part is different from the second connection part, the first connection part is not included in the second connection part, and the second connection part is not included in the first connection part.

Another aspect of the present disclosure provides an image-forming apparatus. The image-forming apparatus includes a reference-ground supply part, configured to provide a potential reference point; and a conductive connection structure including a conductive part, where the conductive part includes a first connection portion and a second connection portion. The first connection portion is electrically connected to the reference-ground supply part through a first connection part in order to be connected to the potential reference point provided by the reference-ground supply part; and the second connection portion is electrically connected to the reference-ground supply part through a second connection part in order to be connected to the potential reference point provided by the reference-ground supply part, where the first connection part is different from the second connection part, the first connection part is not included in the second connection part, and the second connection part is not included in the first connection part.

Another aspect of the present disclosure provides an image-forming apparatus. The image-forming apparatus includes a reference-ground supply part; and a conductive connection structure, including a conductive part, where the conductive part includes a first connection portion and a second connection portion. The first connection portion is electrically connected to a reference-ground supply part disposed in a main body of an image-forming apparatus through a first connection part, in order to be connected to a potential reference point provided by the reference-ground supply part; and the second connection portion is electrically connected to the reference-ground supply part through a second connection part, where the first connection part is different from the second connection part, the first connection part is not included in the second connection part, and the second connection part is not included in the first connection part.

Other aspects of the present disclosure may be understood by those skilled in the art in light of the description, the claims, and the drawings of the present disclosure.

### BRIEF DESCRIPTION OF THE DRAWINGS

To clearly describe technical solutions of various embodiments of the present disclosure, the drawings which need to be used for describing various embodiments are described below. Obviously, the drawings in the following description are merely some embodiments of the present disclosure. For those skilled in the art, other drawings may be obtained in accordance with the drawings without creative efforts.

FIG. 1 illustrates a structural schematic of a conductive connection structure provided by exemplary embodiments of the present disclosure.

FIG. 2 illustrates another structural schematic of a conductive connection structure provided by exemplary embodiments of the present disclosure.

FIG. 3 illustrates another structural schematic of a conductive connection structure provided by exemplary embodiments of the present disclosure.

FIG. 4 illustrates another structural schematic of a conductive connection structure provided by exemplary embodiments of the present disclosure.

FIG. 5 illustrates a structural schematic of a process cartridge chip provided by exemplary embodiments of the present disclosure.

FIG. 6 illustrates an installation schematic of a process cartridge chip provided by exemplary embodiments of the present disclosure.

FIG. 7 illustrates another installation schematic of a process cartridge chip provided by exemplary embodiments of the present disclosure.

FIG. 8 illustrates a structural schematic of an image-forming apparatus provided by exemplary embodiments of the present disclosure.

FIG. 9 illustrates another structural schematic of an image-forming apparatus provided by exemplary embodiments of the present disclosure.

FIG. 10 illustrates another structural schematic of an image-forming apparatus provided by exemplary embodiments of the present disclosure.

FIG. 11 illustrates another structural schematic of an image-forming apparatus provided by exemplary embodiments of the present disclosure.

FIG. 12 illustrates another structural schematic of an image-forming apparatus provided by exemplary embodiments of the present disclosure.

FIG. 13 illustrates another structural schematic of an image-forming apparatus provided by exemplary embodiments of the present disclosure.

FIG. 14 illustrates another structural schematic of an image-forming apparatus provided by exemplary embodiments of the present disclosure.

FIG. 15 illustrates another structural schematic of an image-forming apparatus provided by exemplary embodiments of the present disclosure.

FIG. 16 illustrates another structural schematic of an image-forming apparatus provided by exemplary embodiments of the present disclosure.

FIG. 17 illustrates another structural schematic of an image-forming apparatus provided by exemplary embodiments of the present disclosure.

### DETAILED DESCRIPTION

In order to better understand the technical solutions of the present disclosure, embodiments of the present disclosure are described in detail below with reference to accompanying drawings.

It should be understood that described embodiments are only some of embodiments of the present disclosure, rather than all of embodiments. Based on embodiments in present disclosure, all other embodiments obtained by those skilled in the art without making creative efforts should fall within the protection scope of present disclosure.

The terms used in embodiments of the present disclosure are only for the purpose of describing specific embodiments and not intended to limit the present disclosure. As used in embodiments and appended claims, the singular forms “a,” “the” and “said” are also intended to include plural forms, unless the context clearly dictates otherwise.

It should be understood that the term “and/or” used in the present disclosure is only an association relationship describing related objects, indicating that there may be three relationships. For example, A and/or B may indicate three cases: A alone, both A and B, and B alone. In addition, the character “/” in the present disclosure indicate that related objects are an “or” relationship.

Before a detailed description of embodiments of the present disclosure, terms that may be applied in embodiments of the present disclosure are first defined. For a potential reference point, a certain point A in a circuit is selected as the potential reference point, which indicates that the potential at such point is configured to be zero. The potential reference point is marked with a symbol “⊥” in the circuit. In practice, the potential reference point is chosen to be ground potential, in other words, the ground potential is chosen to be zero potential. In electronic circuits, a common point or a housing is selected as zero potential. It should be noted that, although the potential of the potential reference point is specified to be zero potential, actual potential of such potential reference point is not necessarily zero. For the convenience of subsequent description, the connection to the potential reference point may also be referred to as “ground”.

Currently, image-forming apparatuses such as printers, copiers, faxes and multifunctional machines are detachably installed with process cartridges for image formation. The process cartridge may be an ink cartridge, a toner cartridge or the like. The process cartridge is disposed with a process cartridge chip. The process cartridge chip is disposed with four contacts respectively including a power contact (e.g., volt current condenser or VCC), a data signal contact (e.g., serial data or SDA), a clock signal contact (e.g., CLK) and a grounding contact (GND).

In the image-forming apparatus, each sheet metal of the image-forming apparatus is grounded and electrically connected to each other. A data board of the image-forming apparatus is fixed on the sheet metal of the main body of the image-forming apparatus through locking screws, thereby achieving grounding. The data board is connected to a part of conductive terminals disposed on the image-forming apparatus. When the process cartridge is installed on the image-forming apparatus, another part of the conductive terminals may be electrically connected to conductive contacts of the process cartridge chip. In such way, the process cartridge chip may communicate with the data board and achieve grounding through the data board.

However, if the electrical connection between the conductive terminals disposed on the image-forming apparatus and the data board is unstable, it may result in not direct grounding, abnormal grounding and the like of the process cartridge chip, thereby affecting communication between the process cartridge chip and the image-forming apparatus.

It should be noted that the image-forming apparatus may include an image-forming control unit. The image-forming control unit may be an SoC (System on Chip). The SoC is a miniature system including multiple system parts configured to control image-forming processing operations of the image-forming apparatus, for example, performing linear correction, noise reduction, bad pixel removal, detail enhancement and the like on the image data to improve image output quality. The image-forming control unit may be also configured to perform processing operations related to data transmission and reception, command transmission and reception, and engine control of printing images. For example, the image-forming control unit may send and receive data, print engine control commands, status and the like through an interface unit (including but not limited to a USB port, a wired network port, a wireless network port, other interface, and/or the like). The image-forming control unit may be a data board.

In order to solve above technical problems, embodiments of the present disclosure provide a conductive connection structure and an image-forming apparatus. The conductive connection structure includes a conductive part; the conductive part includes a first connection portion and a second connection portion; the first connection portion is configured to be electrically connected to a reference-ground supply part disposed in a main body of the image-forming apparatus through a first connection part, in order to be connected to a potential reference point provided by the reference-ground supply part; and the second connection portion is configured to be connected to the reference-ground supply part through a second connection part. The first connection part is different from the second connection part. The first connection part is not included in the second connection part, and the second connection part is not included in the first connection part. That is, above-mentioned conductive connection structure includes the conductive part; the first connection portion of the conductive part may be electrically connected to the reference ground disposed in the main body of the image-forming apparatus through the first connection part, such that the conductive part may be connected to the potential reference point provided by the reference-ground supply part through the first connection portion; and furthermore, the second connection portion of the conductive part may be electrically connected to the reference-ground supply part through the second connection part, such that the conductive part may be connected to the potential reference point provided by the reference-ground supply part through the second connection portion. The first connection part is not included in the second connection part, and the second connection part is not included in the first connection part. Therefore, even if one of the first connection portion and the second connection portion is not connected to the potential reference point provided by the reference-ground supply part, the conductive part may still be connected to the potential reference point provided by the reference-ground supply part through another connection portion. In such way, through the conductive part, stable connection to the potential reference point provided by the reference-ground supply part may be achieved. The conductive connection structure is described in detail hereinafter.

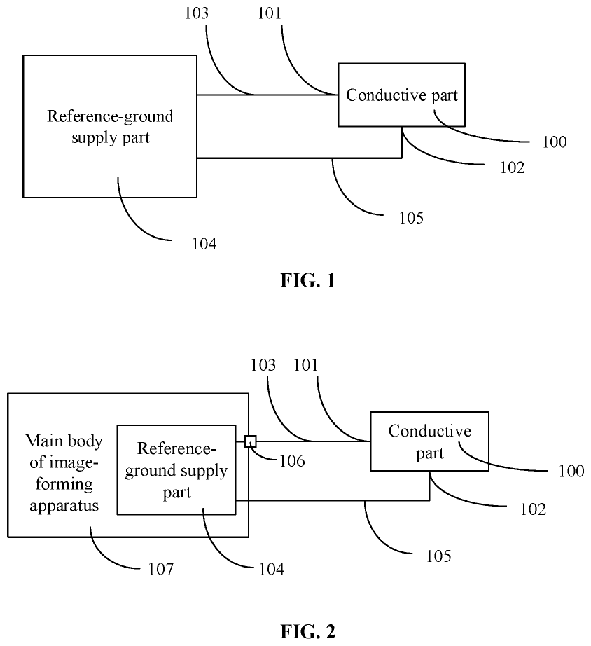

FIG. 1 illustrates a structural schematic of a conductive connection structure provided by exemplary embodiments of the present disclosure. The conductive connection structure may include a conductive part 100; the conductive part 100 may include a first connection portion 101 and a second connection portion 102; the first connection portion 101 may be configured to be electrically connected to a reference-ground supply part 104 disposed in an image-forming apparatus main body 107 (i.e., the main body of the image-forming apparatus) through a first connection part 103, in order to be connected to the potential reference point provided by the reference-ground supply part 104; and the second connection portion 102 may be configured to be electrically connected to the reference-ground supply part 104 through a second connection part 105. The first connection part 103 may be different from the second connection part 105. The first connection part 103 may be not included in the second connection part 105, and the second connection part 105 may be not included in the first connection part 103.

For example, the conductive connection structure may include the conductive part 100; and the conductive part 100 may include the first connection portion 101 and the second connection portion 102. When the conductive connection structure is used in the image-forming apparatus such as a printer, a copier and/or the like, the first connection portion 101 may be electrically connected to the reference-ground supply part 104 disposed in the image-forming apparatus main body 107 through the first connection part 103, in order to be connected to the potential reference point provided by the reference-ground supply part 104; and the second connection portion 102 may be electrically connected to the reference-ground supply part 104 disposed in the image-forming apparatus main body 107 through the second connection part 105, in order to be connected to the potential reference point provided by the reference-ground supply part 104. The reference-ground supply part 104 disposed in the image-forming apparatus main body 107 may be a data board or sheet metal disposed in the image-forming apparatus, or a power board that supplies power to the data board, or another part in the image-forming apparatus capable of providing a potential reference point, which may not be limited in the present disclosure. In such way, the conductive connection structure may be connected to the potential reference points provided by the reference-ground supply part 104 through the first connection portion 101 and the second connection portion 102, respectively. Since the first connection part 103 and the second connection part 105 are different and not included with each other, two paths of connecting to the potential reference point may not affect each other. When any one path is unstable, the conductive part may be connected to the potential reference point through another path, thereby achieving stable access to the potential reference point.

As an optional implementation, as shown in FIG. 2, the first connection portion 101 may be configured to be electrically connected to the reference-ground supply part 104 by electrically connecting to an electrical contact portion 106 disposed on the image-forming apparatus main body 107, thereby implementing connection to the potential reference point provided by the reference-ground supply part 104.

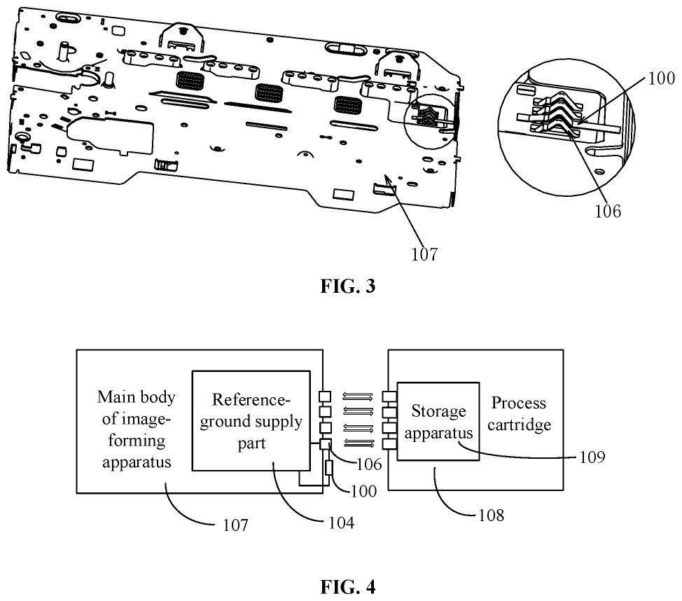

For example, the image-forming apparatus main body 107 may be disposed with the electrical contact portion 106. At this point, the first connection portion 101 may be configured to be electrically connected to the reference-ground supply part 104 by being connected to the electrical contact portion 106 disposed on the image-forming apparatus main body 107, thereby being connected to the potential reference point provided by the reference-ground supply part 104. For example, the electrical contact portion 106 may be a contact elastic piece disposed on the sheet metal frame of the image-forming apparatus main body 107, and the conductive part 100 may be a conductive tape, a wire or the like. As shown in FIG. 3, the conductive part 100 is the conductive tape, which is taken as an example. The conductive tape may be electrically connected to the reference-ground supply part 104 disposed in the image-forming apparatus main body 107. A part of the conductive tape may be electrically connected to the reference-ground supply part 104 by electrically connecting to the contact elastic piece, thereby electrically connecting to the potential reference point provided by the reference-ground supply part 104; and another part of the conductive tape may be directly attached to the sheet metal of the image-forming apparatus main body 107. Since the sheet metal may provide the potential reference point, the conductive tape may be electrically connected to the conductive elastic piece and the sheet metal respectively, thereby being stably connected to the potential reference point. Optionally, when the conductive part 100 is a wire, one end of the wire may be wrapped around the contact elastic piece, and another end may be electrically connected to the reference-ground supply part 104, thereby being connected to the potential reference point. Optionally, one end of the conductive part 100 may be a clip for clamping the conductive contact elastic piece, and another end may be attached to the sheet metal of the image-forming apparatus or directly connected to the potential reference point.

As an optional implementation, as shown in FIG. 4, the electrical contact portion 106 may be configured to be electrically connected to an electrical contact of a storage apparatus 109 installed on a process cartridge 108; and the process cartridge 108 may be detachably installed on the image-forming apparatus main body 107.

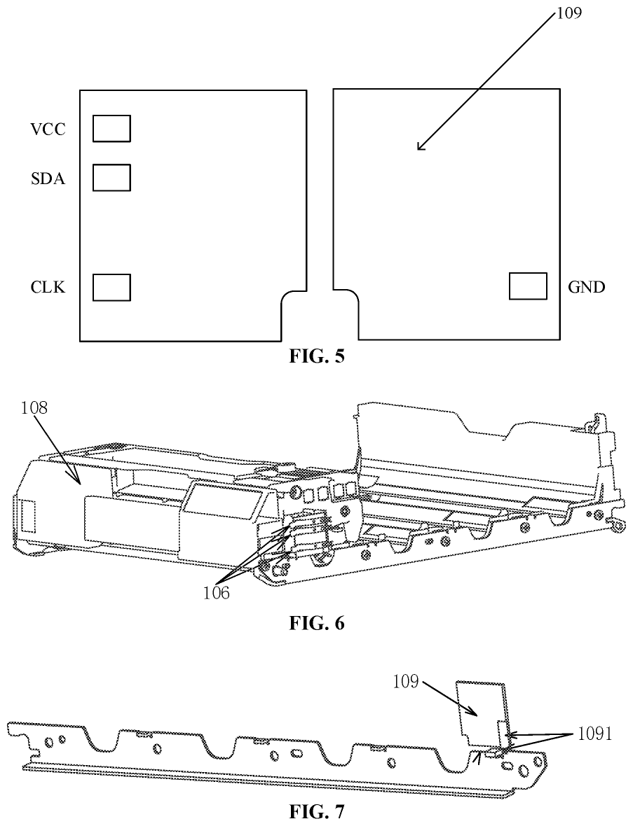

For example, the image-forming apparatus may further include the process cartridge 108. The process cartridge 108 may be detachably installed on the image-forming apparatus main body 107, and the storage apparatus 109 may be installed on the process cartridge 108. For example, the storage apparatus 109 may be a process cartridge chip. At this point, the electrical contact portion 106 may be configured to be electrically connected to the electrical contact of the storage apparatus 109 installed on the process cartridge 108, where the portion of the electrical contact portion 106 used for grounding may be electrically connected to the electrical (ground) contact in the storage apparatus 109. Since the grounding portion of the electrical contact portion 106 has been electrically connected to the conductive connection structure to be connected to the potential reference point, the storage apparatus 109 may be electrically connected to the electrical contact portion 106, thereby being connected to the potential reference point. Obviously, the storage apparatus 109 may also be electrically connected to another reference-ground supply part, thereby being connected to the potential reference point. For example, the storage apparatus 109 may be disposed with a grounding contact at another position, and the grounding contact may be electrically connected to the reference-ground supply part 104 disposed on the image-forming apparatus main body 107 through an electrical connection part 1091, thereby being connected to the potential reference point. As shown in FIG. 5, the storage apparatus 109 may be a process cartridge chip; the front of the process cartridge chip may be disposed with at least three electrical contacts including a power contact (volt current condenser VCC), a data signal contact (serial data SDA), and a clock signal contact (CLK); and the back of the process cartridge chip may be disposed with a grounding contact (GND). As shown in FIG. 6, when the process cartridge chip is installed on the process cartridge 108 and the process cartridge 108 is placed on a drawer and loaded in the image-forming apparatus, three contacts on the front side of the process cartridge chip may form electrical connections with three conductive contact elastic pieces disposed on the image-forming apparatus main body 107, the conductive contact elastic pieces may be electrically connected to a connection plate, and the process cartridge chip may communicate with the image-forming apparatus. As shown in FIG. 7, the grounding contact on the back of the process cartridge chip may be in contact with the sheet metal of the printer drawer through the electrical connection part 1091. When the printer drawer is installed on the image-forming apparatus, the sheet metal of the drawer may be electrically connected to the sheet metal of the image-forming apparatus main body 107 to be connected to the potential reference point, such that the grounding contact on the back of the process cartridge chip may be grounded. Moreover, the grounding contact may be disposed on the back of the chip, which may facilitate the contact with the sheet metal of the drawer, reduce electrical connection difficulty and improve electrical connection stability. In addition, when the storage apparatus 109 is also electrically connected to other reference-ground supply parts in order to be connected to the potential reference point, the layout of all contacts on the chip may also be that the power contact (volt current condenser VCC), the data signal contact (serial data SDA), the clock signal contact (CLK), the grounding contact (GND)) may be disposed on a same side of the chip; or the layout of all contacts on the chip may be configured using other suitable manners.

As an optional implementation, the reference-ground supply part 104 may include an image-forming control unit and/or a power supply unit.

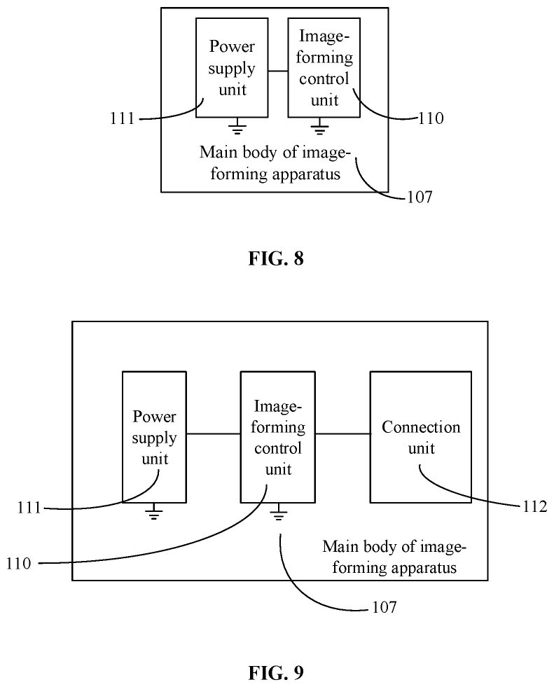

For example, as shown in FIG. 8, the image-forming apparatus main body 107 may be disposed with an image-forming control unit 110 and a power supply unit 111, where the power supply unit 111 may be configured to supply power to the image-forming control unit 110. Since both the image-forming control unit 110 and the power supply unit 111 can provide potential reference points, the reference-ground supply part 104 may be the image-forming control unit 110 and/or the power supply unit 111. Therefore, the first connection portion 101 may be electrically connected to the image-forming control unit 110 or the power supply unit 111 through the first connection portion 103, thereby being connected to the potential reference point provided by the reference-ground supply part 104.

As an optional implementation method, the image-forming apparatus main body 107 may also be disposed with a connection unit. The connection unit may be electrically connected to the image-forming control unit 110 and the electrical contact portion 106, respectively. The first connection portion 101 may be configured to be electrically connected to the image-forming control unit 110 by electrically connecting to the connection unit, thereby being connected to the potential reference point provided by the image-forming control unit 110.

For example, as shown in FIG. 9, in addition to the image-forming control unit 110 and the power supply unit 111, the image-forming apparatus main body 107 may also be disposed with a connection unit 112. The connection unit 112 may be electrically connected to the image-forming control unit 110 and the electrical contact portion 106, respectively. When the process cartridge 108 is detachably installed on the image-forming apparatus main body 107, the electrical contact of the storage apparatus 109 in the process cartridge 108 may be electrically connected to the electrical contact portion 106, and then may be electrically connected to the image-forming control unit 110 through the connection unit 112. Therefore, the communication between the storage apparatus 109 and the image-forming control unit 110 may be realized, and the grounding contact of the storage apparatus 109 may be grounded through the image-forming control unit 110. Furthermore, the electrical contact portion 106 may be also electrically connected to the first connection portion 101 of the conductive part 100, and the second connection portion 102 of the conductive part 100 may be electrically connected to the reference-ground supply part 104 through the second connection part 105. Therefore, even if the grounding between the connection unit 112 and the image-forming control unit 110 is unstable, the electrical contact portion 106 may still be grounded through the second connection portion 102 of the conductive part 100. It may prevent unstable grounding of the storage apparatus 109 of the process cartridge 108 from affecting the communication between the storage apparatus 109 and the image-forming control unit 110.

The first connection portion 101 may be configured to be electrically connected to the image-forming control unit 110 by electrically connecting to the connection unit 112, thereby being connected to the potential reference point provided by the image-forming control unit 110.

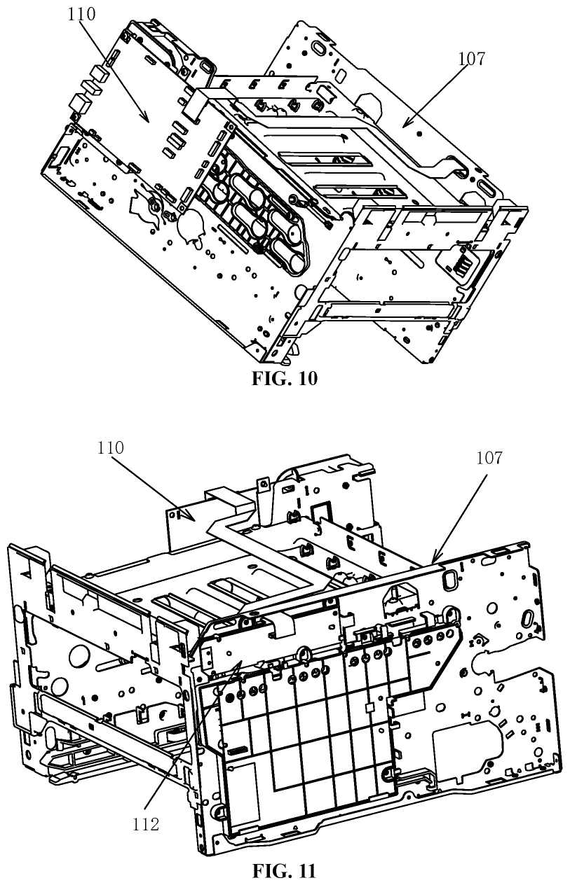

For example, in the printer, the image-forming control unit 110 may be a data board, and the connection unit 112 may be a connection board. As shown in FIG. 10, the data board 110 of the printer may be fixed on the sheet metal of the printer (e.g., image-forming apparatus) main body 107 through locking screws. Since the sheet metal of the printer main body 107 is grounded, the data board may be grounded through the sheet metal of the printer main body 107. That is, both the sheet metal of the printer main body 107 and the data board may be the reference-ground supply parts to provide the potential reference points. As shown in FIG. 11, the connection board 112 of the printer may be electrically connected to the data board 110, such that the connection board of the printer may be grounded through the data board.

It should be noted that in the image-forming apparatus, the connection unit 112 and the image-forming control unit 110 may be disposed separately, or the connection unit 112 may be integrated into the image-forming control unit 110, which may not be limited in the present disclosure.

As an optional implementation, reference-ground supply part 104 may further include the sheet metal of the image-forming apparatus main body 107. The second connection portion 102 may be configured to be electrically connected to the reference-ground supply part 104 by electrically connecting to the sheet metal, thereby being connected to the potential reference point provided by the reference-ground supply part 104.

For example, the image-forming apparatus main body 107 may further include a sheet metal such as a housing sheet metal, a frame body sheet metal, a drawer sheet metal or the like of the image-forming apparatus; and above-mentioned sheet metals of the image-forming apparatus main body 107 may be connected to each other. The sheet metals on the image-forming apparatus main body 107 may be grounded, that is, the sheet metals, which are connected to each other, on the image-forming apparatus main body 107 may all provide the potential reference points. Therefore, the second connection portion 102 may be electrically connected to the sheet metal on the image-forming apparatus main body 107 to be connected to the potential reference point.

As disclosed above, through above conductive connection structure, the first connection portion of the conductive part in the conductive connection structure may be electrically connected to the image-forming control unit through the connection unit in order to be connected to the potential reference point; and the second connection portion of the conductive part may be electrically connected to the sheet metal in order to be connected to the potential reference point. Furthermore, the connection unit of the image-forming apparatus main body 107 may be also electrically connected to the electrical contact portion, such that the electrical contact portion may be connected to the potential reference points through the first connection portion and the second connection portion of the conductive part, thereby achieving stable grounding. In such way, when the process cartridge 108 is installed on the image-forming apparatus main body 107, the electrical contact portion may be configured to be electrically connected to the electrical contact of the storage apparatus 109 installed on the process cartridge 108, such that the electrical contact of the storage apparatus 109 installed on the process cartridge 108 may be stably grounded through the electrical contact portion that has been connected to the potential reference point.

Embodiments of the present disclosure provide an image-forming apparatus. The image-forming apparatus may include the reference-ground supply part and the conductive connection structure as described above. The image-forming apparatus may include the conductive connection structure described in FIG. 1, FIG. 2 or FIG. 4.

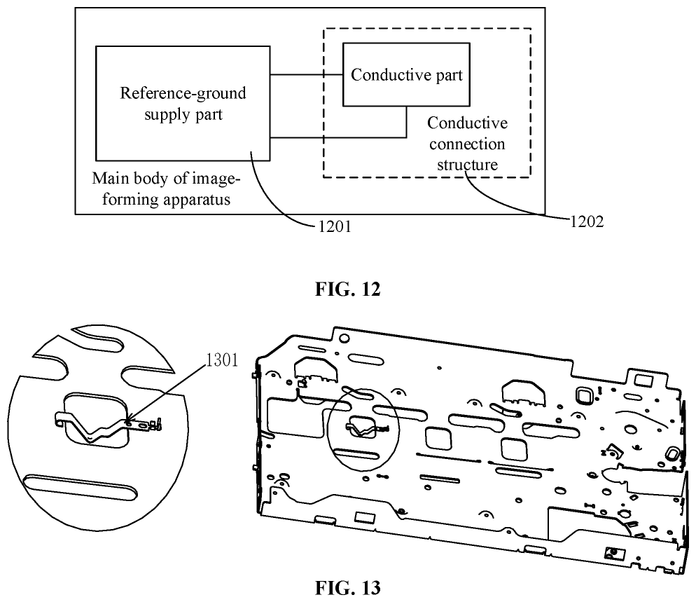

FIG. 12 illustrates another structural schematic of an image-forming apparatus provided by exemplary embodiments of the present disclosure. The image-forming apparatus may include a reference-ground supply part 1201, configured to provide the potential reference point; and a conductive connection structure 1202, where the conductive connection structure may include a conductive part, and the conductive part may include the first connection portion and the second connection portion. The first connection portion may be electrically connected to the reference-ground supply part through the first connection part in order to be connected to the potential reference point provided by the reference-ground supply part. The second connection portion may be electrically connected to the reference-ground supply part through the second connection portion in order to be connected to the potential reference point provided by the reference-ground supply part. The first connection part may be different from the second connection part, the first connection part may be not included in the second connection part, and the first connection part may be not included in the second connection part.

For example, the image-forming apparatus may include the reference-ground supply part 1201 and the conductive connection structure 1202. The conductive connection structure 1202 may include conductive parts. The first connection portion of the conductive part may be electrically connected to the reference-ground supply part through the first connection part in order to be connected to the potential reference point. The second connection portion may be electrically connected to the reference-ground supply part through the second connection portion in order to be connected to the potential reference point. For example, as shown in FIG. 13, the conductive connection structure 1202 may be a conductive contact elastic piece 1301. The conductive contact elastic piece 1301 may be electrically connected to the reference-ground supply part, disposed in the image-forming apparatus, which for example, may be the sheet metal of the main body of the image-forming apparatus.

As an optional implementation, the image-forming apparatus may further include the electrical contact portion; and the first connection portion may be electrically connected to the electrical contact portion to be connected to the reference-ground supply part 1201.

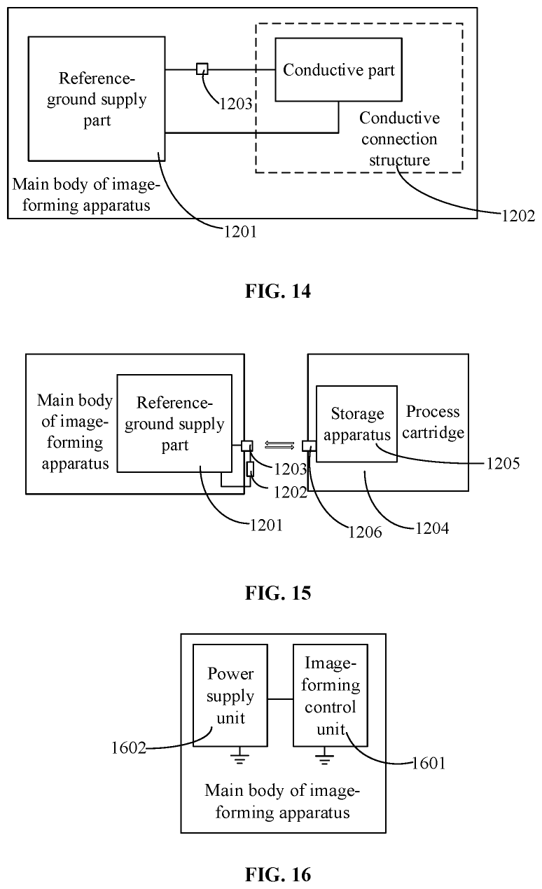

For example, as shown in FIG. 14, the image-forming apparatus may further include an electrical contact portion 1203. One end of the electrical contact portion 1203 may be electrically connected to the reference-ground supply part 1201 disposed in the main body of the image-forming apparatus, and another end of the electrical contact portion 1203 may be electrically connected to the first connection portion of the conductive part in the conductive connection structure 1202. Therefore, the first connection portion may be electrically connected to the electrical contact part to be connected to the reference-ground supply part 1201.

As an optional implementation, the electrical contact portion 1203 may be configured to be electrically connected to the electrical contact of the storage apparatus 1205 installed on the process cartridge; and the process cartridge may be detachably installed on the main body of the image-forming apparatus.

For example, as shown in FIG. 15, when the process cartridge 1204 is detachably installed on the image-forming apparatus, the electrical contact portion 1203 may be configured to be electrically connected to the electrical contact 1206 of the storage apparatus 1205 installed on the process cartridge 1204. For example, the storage apparatus 1205 may be the process cartridge chip, such that the storage apparatus 1205 may communicate with other modules disposed in the main body of the image-forming apparatus.

As an optional implementation, the reference-ground supply part 1201 may include an image-forming control unit and/or a power supply unit.

For example, as shown in FIG. 16, the image-forming apparatus may be disposed with an image-forming control unit 1601 and a power supply unit 1602. The power supply unit 1602 may be configured to provide power to the image-forming control unit 1601. For example, in the printer, the image-forming control unit 1601 may be a data board. Since both the image-forming control unit 1601 and the power supply unit 1602 can provide potential reference points, the reference-ground supply part 1201 may be the image-forming control unit 1601 and/or the power supply unit 1602.

As an optional implementation manner, the image-forming apparatus may further include the connection unit. The connection unit may be electrically connected to the image-forming control unit and the electrical contact part, respectively. The first connection portion may be electrically connected to the image-forming control unit by electrically connecting to the connection unit, thereby being connected to the potential reference point provided by the image-forming control unit.

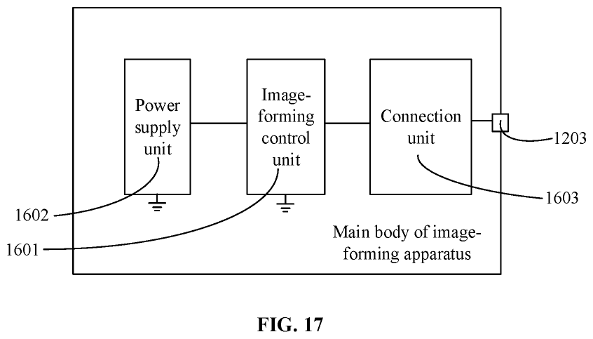

For example, as shown in FIG. 17, in addition to the image-forming control unit 1601 and the power supply unit 1602, the image-forming apparatus may further include a connection unit 1603. For example, the connection unit 1603 may be a connection board. The connection unit 1603 may be electrically connected to the image-forming control unit 1601 and the electrical contact portion 1203, respectively. The first connection portion may be configured to be electrically connected to the image-forming control unit 1601 by electrically connecting to the connection unit 1603, thereby being connected to the potential reference point provided by the image-forming control unit 1601.

As an optional implementation, the image-forming apparatus may further include the main body, and the reference-ground supply part may further include the sheet metal of the main body. The second connection portion may be electrically connected to the reference-ground supply part by electrically connecting to the sheet metal, thereby being connected to the potential reference point provided by the reference-ground supply part.

For example, the image-forming apparatus may further include the main body, and the reference-ground supply part may further include a sheet metal such as a housing sheet metal, a frame body sheet metal, a drawer sheet metal or the like of the image-forming apparatus. Above-mentioned sheet metals of the image-forming apparatus main body may be connected to each other. The sheet metals on the image-forming apparatus main body may be grounded, that is, the sheet metals, which are connected to each other, on the image-forming apparatus main body may all provide the potential reference points. Therefore, the second connection portion may be electrically connected to the sheet metal on the main body to be connected to the potential reference point, that is, the second connection portion may be grounded.

The above are only optional embodiments of the present disclosure; and same and similar parts between various embodiments in the present disclosure may be referred to each other, which may not limit the protection scope of the present disclosure. Any changes or substitutions that may be easily developed by those skilled in the art within the technical scope disclosed in the present disclosure should be covered by the protection scope of the present disclosure.

What is claimed is:

1. A conductive connection structure, comprising:
a conductive part, including a first connection portion and a second connection portion, wherein:
the first connection portion is electrically connected to a reference-ground supply part disposed in a main body of an image-forming apparatus through a first connection part, in order to be connected to a potential reference point provided by the reference-ground supply part; and
the second connection portion is electrically connected to the reference-ground supply part through a second connection part, wherein the first connection part is different from the second connection part, the first connection part is not included in the second connection part, and the second connection part is not included in the first connection part.

2. The conductive connection structure according to claim 1, wherein:
the first connection portion is electrically connected to the reference-ground supply part, by electrically connecting to an electrical contact portion disposed on the main body of the image-forming apparatus, in order to be connected to the potential reference point provided by the reference-ground supply part.

3. The conductive connection structure according to claim 2, wherein:
the electrical contact portion is electrically connected to an electrical contact of a storage apparatus installed on a process cartridge; and the process cartridge is detachably installed on the main body of the image-forming apparatus.

4. The conductive connection structure according to claim 1, wherein:
the reference-ground supply part includes an image-forming control unit and/or a power supply unit.

5. The conductive connection structure according to claim 4, wherein:
the main body of the image-forming apparatus is further disposed with a connection unit; the connection unit is electrically connected to the image-forming control unit and an electrical contact portion respectively; and the first connection portion is electrically connected to the image-forming control unit, by electrically connecting to the connection unit, in order to be connected to a potential reference point provided by the image-forming control unit.

6. The conductive connection structure according to claim 1, wherein:
the reference-ground supply part further includes a sheet metal of the main body of the image-forming apparatus; and the second connection portion is electrically connected to the reference-ground supply part, by electrically connecting to the sheet metal, in order to be connected to the potential reference point provided by the reference-ground supply part.

7. An image-forming apparatus, comprising:
a reference-ground supply part, configured to provide a potential reference point; and
a conductive connection structure including a conductive part, wherein the conductive part includes a first connection portion and a second connection portion, wherein:
the first connection portion is electrically connected to the reference-ground supply part through a first connection part, in order to be connected to the potential reference point provided by the reference-ground supply part; and the second connection portion is electrically connected to the reference-ground supply part through a second connection part, in order to be connected to the potential reference point provided by the reference-ground supply part, wherein the first connection part is different from the second connection part, the first connection part is not included in the second connection part, and the second connection part is not included in the first connection part.

8. The image-forming apparatus according to claim 7, wherein:
the image-forming apparatus further includes an electrical contact portion; and the first connection portion is electrically connected to the electrical contact portion in order to be connected to the potential reference point provided by the reference-ground supply part.

9. The image-forming apparatus according to claim 8, wherein:
the electrical contact portion is electrically connected to an electrical contact of a storage apparatus installed on a process cartridge; and the process cartridge is detachably installed on a main body of the image-forming apparatus.

10. The image-forming apparatus according to claim 7, wherein:
the reference-ground supply part includes an image-forming control unit and/or a power supply unit.

11. The image-forming apparatus according to claim 10, further including:
a connection unit, wherein the connection unit is electrically connected to the image-forming control unit and an electrical contact portion respectively; and the first connection portion is electrically connected to the image-forming control unit, by electrically connecting to the connection unit, in order to be connected to a potential reference point provided by the image-forming control unit.

12. The image-forming apparatus according to claim 7, wherein:
the image-forming apparatus further includes a main body; the reference-ground supply part further includes a sheet metal of the main body of the image-forming apparatus; and the second connection portion is electrically connected to the reference-ground supply part, by electrically connecting to the sheet metal, in order to be connected to the potential reference point provided by the reference-ground supply part.

13. An image-forming apparatus, comprising:
a reference-ground supply part; and
a conductive connection structure, including a conductive part, wherein the conductive part includes a first connection portion and a second connection portion, wherein:
the first connection portion is electrically connected to a reference-ground supply part disposed in a main body of an image-forming apparatus through a first connection part, in order to be connected to a potential reference point provided by the reference-ground supply part; and
the second connection portion is electrically connected to the reference-ground supply part through a second connection part, wherein the first connection part is different from the second connection part, the first connection part is not included in the second connection part, and the second connection part is not included in the first connection part.
